(19) United States
(12) Patent Application Publication
(10) Pub. No.: US 2003/0185648 A1
(43) Pub. Date: Oct. 2, 2003

(54) Set screw with rotating point

(76) Inventor: Donald J. Blaess, Ridgeway, IA (US)

Correspondence Address: TREXLER, BUSHNELL, GIANGIORGI,, BLACKSTONE & MARR, LTD., 105 W. ADAMS STREET, CHICAGO, IL, 60603, US

(21) Appl. No.: 10/379,872

(22) Filed: Mar. 5, 2003

Related U.S. Application Data
(60) Provisional application No. 60/368,231, filed on Mar. 28, 2002.

(51) Int. Cl. F16B 35/00

(52) U.S. Cl. 411/393

(57) ABSTRACT

A fastener such as a set screw which is used for clamping materials. The set screw has an aperture provided at one end thereof for acceptance of a tightening means. An opposite end of the set screw has an aperture which is capable of accepting a shaft portion of a pin member. A head portion of the pin member is positioned outside of the aperture at an end of the set screw and has a point surface which clamps against the materials to be clamped. Upon rotation of the set screw by the tightening means, the pin member also rotates. The pin member continues to rotate with the set screw until the point contacts the material to be clamped. Continued rotation of the set screw forces the pin member to clamp the material, without rotating, such that the material engaged by the pin member will not be damaged during the rotation of the set screw to its final position.

### RELATED APPLICATION (PRIORITY CLAIM)

This application claims the benefit of U.S. Provisional Application Serial No. 60/368,231, filed Mar. 28, 2002.

### BACKGROUND OF THE INVENTION

The present invention relates to threaded fasteners in general and more particularly to a novel point design that is especially useful with set screws.

Generally set screws are engaged in a threaded aperture by a drive tool means, i.e., a screw driver, Allen wrench, or the like, until a tip or end of the set screw engages an object and then the set screw is tightened further by application of more torque until the set screw holds the object being engaged with a desired force.

Set screws, though, can cause problems when they are rotated and tightened down onto an object. For example, one typical use for a set screw would be for an electrical connector wherein the set screw holds a braided electrical wire or the like down tight against a flat surface to establish an electrical connection. Use of standard set screws, however, will tend to cut through, splay and/or twist some of the braids of the electrical wire when an end of the set screw is rotated while in contact with the electrical wire. In another example, when a set screw is used to hold a shaft in place, engagement of the set screw and subsequent removal results in a mark on the shaft.

One suggested remedy in an attempt to overcome these problems is to attach rotatably a washer to the end of a set screw. Thus, when the set screw is rotated, the washer will come into contact with the object to be clamped down and will stop rotating and thus compress the object as the set screw is advanced and tightened. This remedy, though, has its drawbacks.

The set screw and washer assembly is limited in size because the diameter of the washer must be smaller than the diameter of the minor thread of the set screw. Flowing therefrom, all other features of the set screw and washer assembly become smaller to the point that the post diameter of the set screw becomes very fragile. Thus, the smallest set screw that can be used with this configuration could possibly be 5/16″ or ¼″ diameter. Also, the bearing surface on this type of configuration is reduced by the size of the post diameter of the set screw. The end of the set screw where the washer is attached still also continues to rotate such that it can come into contact with and damage the object to be clamped down. Further, such an assembly is limited to only one point style.

### OBJECTS AND SUMMARY OF THE INVENTION

A primary object of an embodiment of the invention is to provide a set screw which will not damage the material to be clamped into place when the set screw is rotated and tightened.

An object of an embodiment of the invention is to provide a set screw having a relatively rotatable pin member proximal to an end thereof which, when the pin member comes into contact with the material to be set or clamped into place, the pin member will stop rotating and compress the material as the set screw is continued to be rotated.

Another object of an embodiment of the invention is to provide a set screw, that can have a number of different relatively rotatable point styles, that will not damage the material to be clamped in place.

Another object of an embodiment of the invention is to provide a set screw that has increased holding power over set screws of the prior art.

Yet another object of an embodiment of the invention is to provide a set screw design which can be used with extremely small set screw configurations.

Still another object of an embodiment of the invention is to provide a set screw which has an increased bearing surface over set screws of the prior art.

Briefly, and in accordance with at least one of the foregoing objects, an embodiment of the present invention provides a set screw with a relatively rotatable point for clamping materials. The set screw has a drive aperture provided at one end thereof for acceptance of a drive tool means. An opposite end of the set screw has an aperture for accepting a shaft portion of a rotatably mounted pin member. A head portion of the pin member is positioned outside the set screw aperture and has a surface which clamps against the materials to be clamped. Upon rotation of the set screw by the drive tool means, the pin member will also initially rotate. The pin member continues to rotate with the set screw until the point contacts the material to be clamped. Continued rotation of the set screw will result in relative rotation, in that the pin member will clamp the material, without further rotation, such that the material will not be damaged during the final rotation of the set screw. While the invention is discussed with regard to a set screw type of fastener, it can be used with other fastener designs such as headed cap screws or the like.

### BRIEF DESCRIPTION OF THE DRAWINGS

The features of the invention which are believed to be novel are described in detail hereinbelow. The organization and manner of the structure and operation of the invention, together with further objects and advantages thereof, may best be understood by reference to the following description taken in connection with the accompanying drawings wherein like reference numerals identify like elements in which:

FIG. 1 is a cross-sectional side view of a pin blank of a first embodiment of the invention;

FIG. 2 is a cross-sectional side view of a set screw blank of a first embodiment of the invention;

FIG. 3 is a cross-sectional side view of the pin blank of FIG. 1 after the pin blank has been rolled or otherwise preliminarily formed in accordance with the first embodiment of the invention;

FIG. 4 is a cross-sectional side view of the set screw blank of FIG. 2 with the pin of FIG. 3 inserted within the aperture end of the set screw blank;

FIG. 5 is a diagrammatic view in cross-section of the set screw blank with the pin inserted therein of FIG. 4, during a thread rolling operation between a pair of dies;

FIG. 6 is a cross-sectional side view of the completed set screw and pin assembly of the first embodiment of the invention;

FIG. 7 is a cross-sectional side view of the pin blank of FIG. 1 after the pin blank has been rolled or otherwise preliminarily formed in accordance with a second embodiment of the invention; and

FIG. 8 is a cross-sectional side view of the completed set screw and pin assembly of the second embodiment of the invention.

### DETAILED DESCRIPTION OF ILLUSTRATED EMBODIMENTS

While this invention may be susceptible to embodiment in different forms or used with screws of a type other than a set screw, there are shown in the drawings and will be described herein in detail, specific embodiments with the understanding that the present disclosure is to be considered an exemplification of the principles of the invention, and is not intended to limit the invention to that as illustrated.

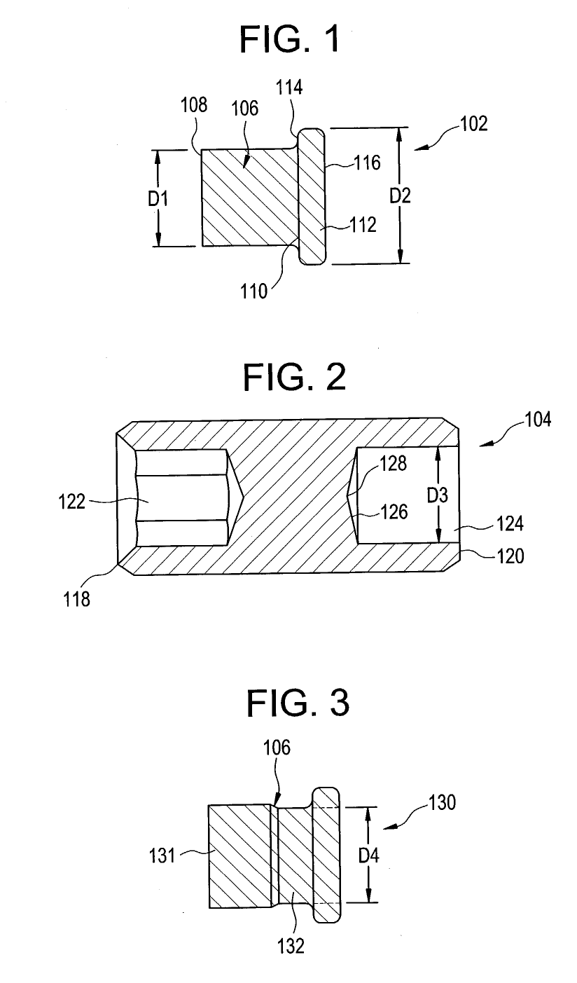

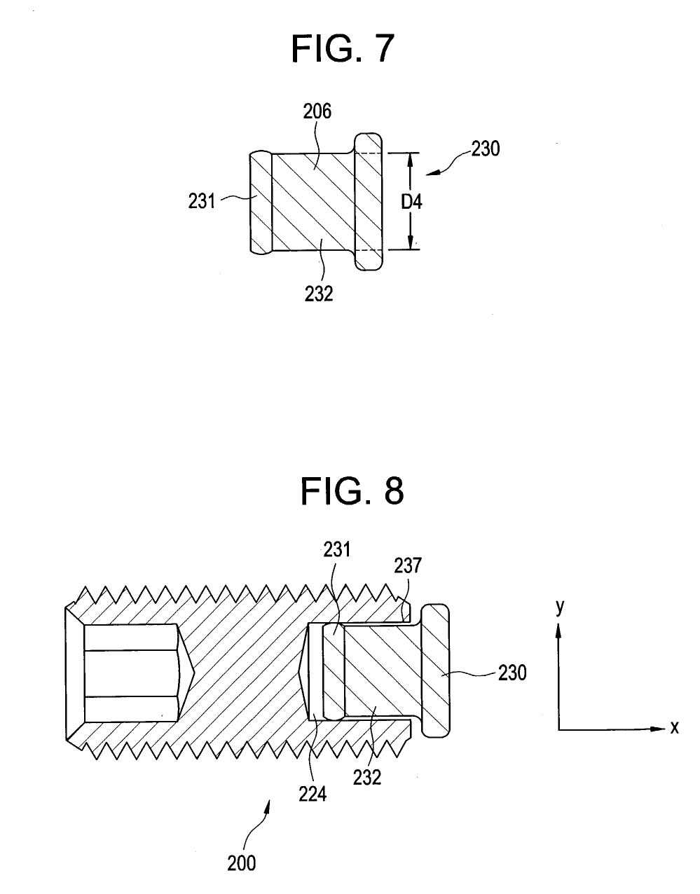

A first embodiment of the set screw 100 which incorporates features of the invention is shown in FIGS. 1-6 with reference numerals being in the one hundreds. A second embodiment of the set screw 200 which incorporates features of the invention is shown in FIGS. 7-8 with reference numerals being in the two hundreds. Like reference numerals denote like elements.

Attention is invited to the first embodiment of the set screw 100 which is illustrated in FIGS. 1-6. The set screw 100 is generally formed from two separate components, a pin blank 102, which is illustrated in FIG. 1, and a set screw blank 104, which is illustrated in FIG. 2. The pin blank 102 and the set screw blank 104 are both preferably formed of metal, preferably steel, although the pin blank 102 could be formed of a different material than the set screw blank 104, such as, nylon, plastic, aluminum, a zinc die cast or copper.

The pin blank 102 includes a generally elongated shaft portion 106 having a first end 108 and a second end 110. The pin blank 102 further includes a head portion 112 at the second end 110 of the shaft portion 106. The shaft portion 106 has a diameter D1 and the head portion 112 has a diameter D2 with diameter D2 being larger than diameter D1 such that a shoulder 114 is provided between the shaft portion 106 and the head portion 112. The outer end or point 116 of the head portion 112, which is opposite of the shoulder 114, can be configured in many different styles, such as cup, knurl, cone, half dog, full dog, oval, or flat, as illustrated in FIG. 1, all of which are known in the art and, therefore, will not be discussed in detail herein.

The set screw blank 104 is generally cylindrical and has a first end 118 and a second end 120. A drive aperture 122 is provided in the set screw blank 104 which opens to the first end 118 of the set screw blank 104. The aperture 122 is capable of accepting a drive tool means (not shown), such as a screwdriver, Allen wrench, or the like, which can engage with walls of the aperture 122 to tighten the set screw 100. The aperture 122 may take on many forms, such as a slot, a recessed hexagonal socket, as illustrated in FIG. 2, or a recess configured in accordance with the TORX® drive system, depending on the tightening means to be utilized.

A generally cylindrical aperture 124 is provided in the set screw blank 104 which opens to the second end 120 of the set screw blank 104. The aperture 124 has a diameter D3, which is slightly larger than the diameter D1 of the shaft portion 106 of the pin blank 102, but is smaller than the diameter D2 of the head portion 112 of the pin blank 102. The aperture 124 may be formed with a bottom aperture wall 126 which ends in a point 128.

The pin blank 102 is rolled to form a pin 130, as illustrated in FIG. 3. After rolling, the shaft portion 106 of the pin 130 has a first diameter portion 131 and a second diameter portion 132 which is positioned between the first diameter portion 131 and the head portion 112. The first diameter portion 131 defines a shoulder portion and has a diameter D1. The second diameter portion 132 is in effect recessed with respect to shoulder 131 and has a diameter D4, which is smaller than the diameter D1 of the shaft portion 106 and the shoulder 131. The second diameter portion 132 has a length which is less than a length of the shoulder portion 131.

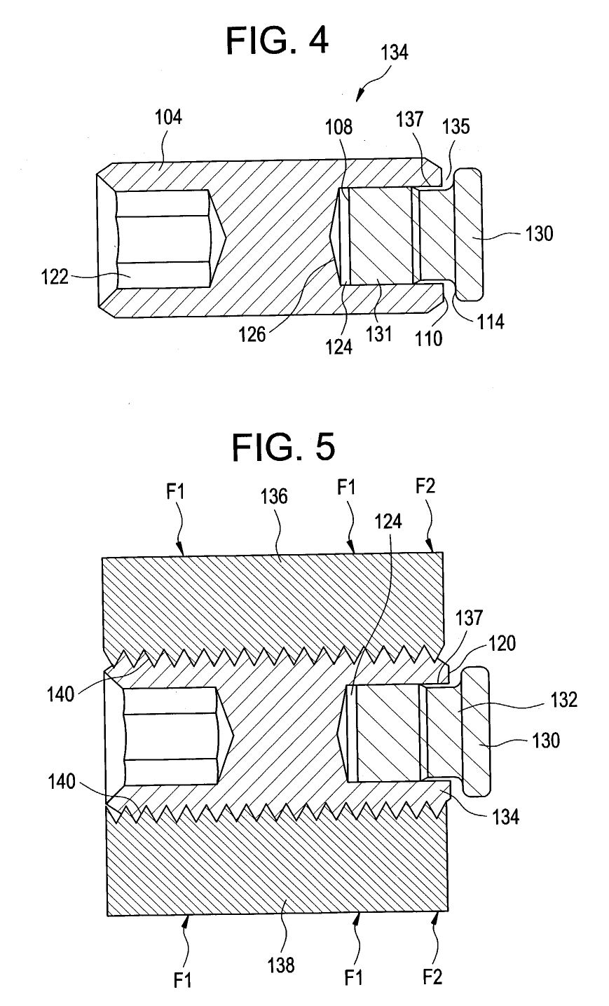

As illustrated in FIG. 4, the first end 108 of the pin 130 is initially inserted or disposed within the aperture 124 to form a set screw blank assembly designated generally as 134. The pin 130 can be inserted into the aperture 124 as the diameter D1 of the first diameter portion 131 is less than the diameter D3 of the aperture 124. The first end 108 of the pin 130 is positioned within the aperture 124 such that the first end 108 does not come into contact with, or be bottomed on, the bottom wall 126 of the aperture 124 of the set screw blank 104. The shoulder 114 of the pin 130 is positioned outside the aperture 124 such that it does not come into contact with, or be bottomed on, the second end 110 of the set screw blank 104, thus providing an initial gap 135 between the shoulder 114 and the second end 110 of the set screw blank 104.

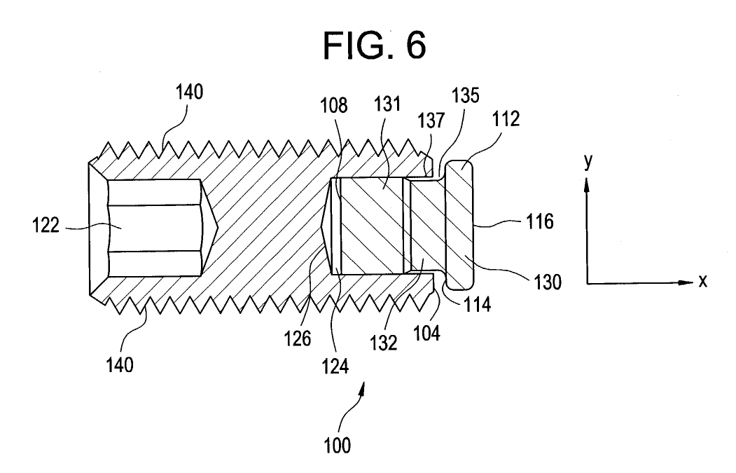

Once the set screw blank assembly 134 is provided, the set screw blank assembly 134 is roll threaded between a pair of thread rolling dies 136, 138, as schematically illustrated in FIG. 5. Along the length of the set screw blank assembly 134, the thread rolling dies 136, 138 provide a force F1 thereto to cold form threads 140 along the outer surface of the set screw blank assembly 134. The cold forming of the threads 140 by dies such as dies 136, 138, is well known in the art. During this procedure, the material along the outer surface of the blank 104 is cold formed into a screw thread profile of the dies 136, 138. This is achieved by the displacement of material, some of which could flow upwardly into the die thread cavities. The flow of the material upwardly into the die cavities serves a unique function in that the threads 140 are formed without constricting the blank 104 in the area of the aperture 124. Thus, the threads 140 are formed without deforming or pinching the blank 104 into restrictive engagement with the pin 102. As the dies 136, 138 approach the end 120 of the set screw blank assembly 134, the dies 136, 138 force the end wall of the aperture 124 inwardly toward the second, reduced diameter portion 132 of the pin 130 at 137. The end wall 137 serves to capture the pin 130 within the aperture 124, as illustrated in FIG. 6, to form the set screw 100 of the first embodiment of the invention. While captured, the pin 130 is free to rotate relative to the now threaded screw blank 104, or vice versa.

Operation of the set screw 100 will now be discussed. The set screw 100 can be utilized to clamp an item, such as braided electrical wire, to form an electrical connector. An operator first positions the item to be clamped onto a surface. The set screw 100 is then aligned with an aperture of a workpiece positioned next to the surface, such that the point 116 will enter the aperture of the workpiece before the remainder of the set screw 100. A drive tool or other form of tightening means, such as a screwdriver or an Allen wrench, is positioned in the aperture 122 of the set screw 100 and rotated to rotate the set screw 100 and to engage the threads 140 of the set screw 100 with the threaded aperture walls of the workpiece. Rotation of the set screw 100 rotates the pin 130 as long as the point 116 does not encounter any resistance. Upon continued rotation of the set screw 100, the point 116 of the head portion 112 of the pin 130 will come into contact with the item to be clamped.

When the point 116 of the pin 130 contacts the item to be clamped and faces resistance from the surface, the pin 130 stops rotating along with the set screw 100, thus preventing the possible marring or damaging of the item to be clamped, which could be caused, if the pin 130 continued to rotate. Upon continued rotation of the set screw 100, the gap 135 provided between the shoulder 114 of the pin 130 and the second end 110 of the set screw blank 104 is closed. The pin 130, though, is preferably dimensioned such that the first end 108 of the pin 130 does not come into contact with, or be bottomed on, the bottom wall 126 of the aperture 124, as the bottoming out produces a tendency to rotate the pin 130 with the set screw 100.

If because of required tolerance variations, the first end 108 of the pin 130 does come into contact with, or be bottomed on, the bottom wall 126 of the aperture 124, the first end 108 of the pin 130 can be cupped or bulbous to create only line or point contact between the set screw 100 and the pin 130 such that the pin 130 still will not rotate with the set screw 100 when the point 116 of the pin 130 is in clamping engagement with the item to be clamped.

Reference is now directed to FIG. 6 and the reference axes “X” and “Y”. As discussed above, the end wall 137 is formed inwardly only slightly toward the reduced diameter portion 132 of pin 130, and thus, along with shoulder portion 131, serves to capture the pin 130 within the aperture 124. The length of reduced diameter portion 132 determines the extent of movement of the pin 130 along the X-axis. This movement is desirable to permit the pin 130 to adopt to varied conditions. This movement, however, should not permit the pin 130 to bottom in the aperture 124, as bottoming could preclude the desired relative rotation. Further, the extent of the shoulder 131 and the difference in the diameters D3 and D1, will determine the extent of movement permitted in the Y axis.

It should be noted that an adhesive (not shown) could also be applied to the point 116 of the pin 130 to provide a stronger clamping engagement by the set screw 100.

Thus, the set screw 100 provides a number of advantages over the prior art. The set screw 100 provides a greater bearing surface than set screws of the prior art and of the set screw and washer assembly discussed hereinabove. Also, the center of the point 116 does not turn which allows the entire point 116 to seat against the item to be clamped. The invention further provides improvements to the holding power of the set screw 100 and prevents surface damage to the secured surface, as long as the point 116 utilized does not have any sharp surfaces, such as in a cone configuration. Further, this design can be used with the smallest set screw into which a hex or TORX® drive can be punched.

Attention is invited to the second embodiment of the set screw 200 which is illustrated in FIGS. 7-8. As the second embodiment of the set screw 200 is virtually identical to the set screw 100 of the first embodiment, the second embodiment of the set screw 200 will only discuss the differences between the first and second embodiments.

The pin blank 202 is rolled to form a rolled pin 230, as illustrated in FIG. 7. After rolling, the shaft portion 206 of the rolled pin 230 has a first diameter or shoulder portion 231 and a second, reduced diameter portion 232 which is positioned between the first diameter portion 231 and the head portion 212. The first diameter portion 231 has a diameter D1. The second diameter portion 232 has a diameter D4, which is smaller than the diameter D1 of the shaft portion 206. The second diameter portion 232 has a length which is greater than a length of the first diameter portion 231.

With regard to the operation of the set screw 200, reference is now directed to FIG. 8 and the reference axes “X” and “Y”. The end wall 237 is formed inwardly only slightly toward the reduced diameter portion 232 of pin 230, and thus, along with shoulder portion 231, serves to capture the pin 230 within the aperture 224. The length of reduced diameter portion 232 determines the extent of movement of the pin 230 along the X-axis. This movement is desirable to permit the pin 230 to adopt to varied conditions. This movement, however, should not permit the pin 230 to bottom in the aperture 224, as bottoming could preclude the desired relative rotation. Further, the extent of the shoulder 231 and the difference in the diameters D3 and D1, will determine the extent of movement permitted in the Y axis. It should be noted that with this embodiment, as the length of the first diameter portion 231 is less than the length of the first diameter portion 131 of the first embodiment, movement of the pin 230 along the Y-axis is not controlled as well as the movement of the pin 130 along the Y-axis.

It should further be noted that the invention is not limited to set screws, as the principles of the invention would work with any type of threaded fastener.

While preferred embodiments of the invention are shown and described, it is envisioned that those skilled in the art may devise various modifications without departing from the spirit and scope of the foregoing description.

What is claimed is:

1. A fastener configured to engage a surface and configured for engagement by a driver, said fastener comprising a drive member having a first end configured for engagement with the driver and a second end; a pin member engaged with said second end of said drive member, said fastener configured such that said pin member rotates along with said drive member for a first period of time while said drive member is driven in a direction using said driver and said fastener configured such that said pin member stops rotating along with said drive member upon said pin member contacting the surface and upon continued driving of said drive member in said direction.

2. A fastener as recited in claim 1, wherein said drive member includes a threaded outer surface.

3. A fastener as recited in claim 1, wherein said pin member includes a non-threaded outer surface, said non-threaded outer surface being disposed in an aperture in said second end of said drive member.

4. A fastener as recited in claim 1, wherein said drive member is configured to captively retain said pin member.

5. A fastener as recited in claim 1, wherein said pin member comprises a head portion and a shaft portion extending from said head portion, at least a portion of said shaft portion being disposed in an aperture in said second end of said drive member.

6. A fastener as recited in claim 1, wherein said pin member comprises a head portion and a shaft portion which includes an enlarged diameter end portion, said shaft portion extending from said head portion, at least a portion of said shaft portion being disposed in an aperture in said second end of said drive member, and said drive member configured to captively retain said enlarged diameter portion of said shaft portion of said pin member.

7. A fastener as recited in claim 1, wherein said pin member comprises a head portion and a shaft portion extending from said head portion, said shaft portion comprising an enlarged diameter portion and a reduced diameter portion, at least a portion of said shaft portion being disposed in an aperture in said second end of said drive member, and said drive member configured to captively retain said enlarged diameter portion of said shaft portion of said pin member.

8. A fastener as recited in claim 7, wherein said enlarged diameter portion is longer along a longitudinal axis of said pin member than is said reduced diameter portion.

9. A fastener as recited in claim 7, wherein said enlarged diameter portion is shorter along a longitudinal axis of said pin member than is said reduced diameter portion.

10. A fastener configured to engage a surface and configured for engagement by a driver, said fastener comprising a set screw member and a pin member engaged with said set screw member, said set screw member having a first end configured to be engaged by a driver, said set screw member having a second end providing an aperture, said pin member being disposed in said aperture, said fastener configured such that said pin member rotates along with said drive member for a first period of time while said drive member is driven in a direction using said driver and said fastener configured such that said pin member stops rotating along with said drive member upon said pin member contacting the surface and upon continued driving of said drive member in said direction.

11. A fastener as recited in claim 10, wherein said set screw member includes a threaded outer surface.

12. A fastener as recited in claim 10, wherein said pin member includes a non-threaded outer surface, said non-threaded outer surface being disposed in an aperture in said second end of said set screw member.

13. A fastener as recited in claim 10, wherein said set screw member is configured to captively retain said pin member.

14. A fastener as recited in claim 10, wherein said pin member comprises a head portion and a shaft portion extending from said head portion, at least a portion of said shaft portion being disposed in an aperture in said second end of said set screw member.

15. A fastener as recited in claim 10, wherein said pin member comprises a head portion and a shaft portion extending from said head portion, said shaft portion comprising an enlarged diameter portion and a reduced diameter portion, at least a portion of said shaft portion being disposed in an aperture in said second end of said set screw member, and said set screw member configured to captively retain said enlarged diameter portion of said shaft portion of said pin member.

16. A fastener as recited in claim 15, wherein said enlarged diameter portion is longer along a longitudinal axis of said pin member than is said reduced diameter portion.

17. A fastener as recited in claim 15, wherein said enlarged diameter portion is shorter along a longitudinal axis of said pin member than is said reduced diameter portion.
